(19) United States
(12) Patent Application Publication
(10) Pub. No.: US 2021/0208744 A1
(43) Pub. Date: Jul. 8, 2021

(54) SYSTEM AND METHOD FOR NAVIGATING CONTENT FROM MULTIPLE USERS ON A DIGITIAL DEVICE

(71) Applicant: IOOI, Rocklin, CA (US)

(72) Inventor: Mark Wood, Irvine, CA (US)

(21) Appl. No.: 17/055,944

(22) PCT Filed: May 16, 2019
(86) PCT No.: PCT/US2019/032733

§ 371 Date: Nov. 16, 2020

Related U.S. Application Data
(60) Provisional application No. 62/672,456, filed on May 16, 2018.

(51) Int. Cl. G06F 3/0482; G06F 3/0484; G06F 16/9535

(52) U.S. Cl. CPC G06F 3/0482; G06F 16/9535; G06F 3/04845

(57) ABSTRACT

An electronic media platform and associated methods for navigating content from multiple users and for sharing information by a user in different forms, wherein the platform maybe used to select, filter, display, content from a plurality of sources and/or user and permit a user to navigate through the content in a logical and easy manner. A user interface includes an active area may be used to display content, summaries, links, navigation inputs, and other information to the user.

### PRIORITY

The instant application claims priority to U.S. Provisional Application No. 62/672,456, filed May 16, 2018, which is incorporated by reference in its entirety herein.

### BACKGROUND

The use of the internet and social media has exploded in the United States and elsewhere. According to some sources, 81% of Americans use social media in 2017, up from only 24% in 2008. A number of Americans use a number of social media sites, including WhatsApp, Twitter, LinkedIn, Snapchat, Pinterest, Instagram, Facebook, and YouTube. Each of these sites provide unique capabilities and communication methods to the individual users. Users therefore may spend unnecessary time logging into different platforms to retrieve information from different sources. Users may also have different networks of people based on the different programs that they are affiliated with.

Given the interest and use of the internet and social media sites, the display of content is limiting, and much of the user interface is unused. In order to generate additional revenues, website owners may put in advertisements or other click through devices that are designed to drive users away from the original site. Close to 70% of an engagement by a user is less than four minutes, and only approximately 28% or less of a page's content is ever read during an average visit.

### BRIEF SUMMARY

Exemplary embodiments described herein include an electronic media platform for sharing information by a user in different forms. Exemplary embodiments may be used to select, filter, display, content from a plurality of sources and/or user and permit a user to navigate through the content in a logical and easy manner.

### BRIEF DESCRIPTION OF THE DRAWINGS

FIGS. 1A-1E illustrate an exemplary user interface according to embodiments described herein.

FIG. 2 illustrates an exemplary user interface according to embodiments described herein.

FIG. 3 illustrates an exemplary user interface according to embodiments described herein.

FIG. 4 illustrates an exemplary user interface according to embodiments described herein.

FIG. 5 illustrates an exemplary user interface according to embodiments described herein.

FIG. 6 illustrates an exemplary user interface according to embodiments described herein.

FIGS. 7A-7H illustrate an exemplary user interface according to embodiments described herein.

FIG. 8 illustrates an exemplary system according to embodiments described herein.

### DETAILED DESCRIPTION

In the following description of preferred embodiments, reference is made to the accompanying drawings which form a part hereof, and in which it is shown by way of illustration specific embodiments in which the invention can be practiced. It is to be understood that other embodiments can be used and structural changes can be made without departing from the scope of the embodiments of this invention.

Exemplary embodiments described herein include an electronic media platform for sharing information by a user in different forms.

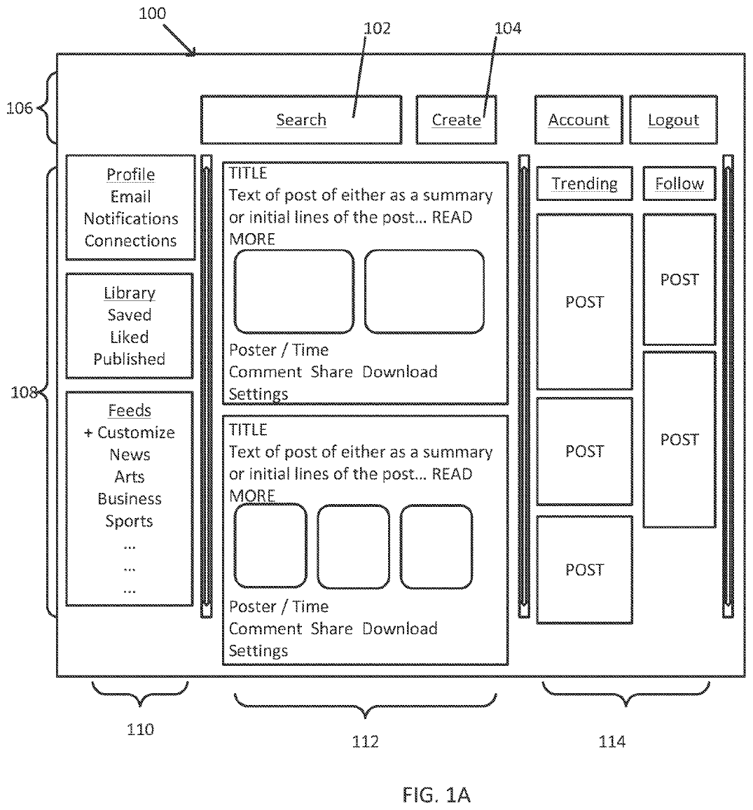

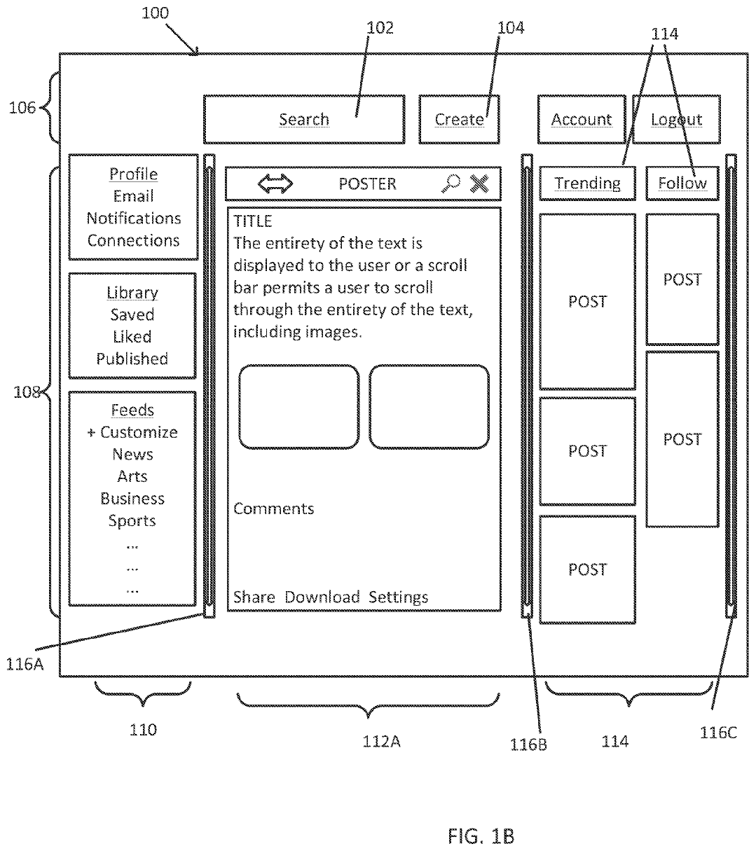

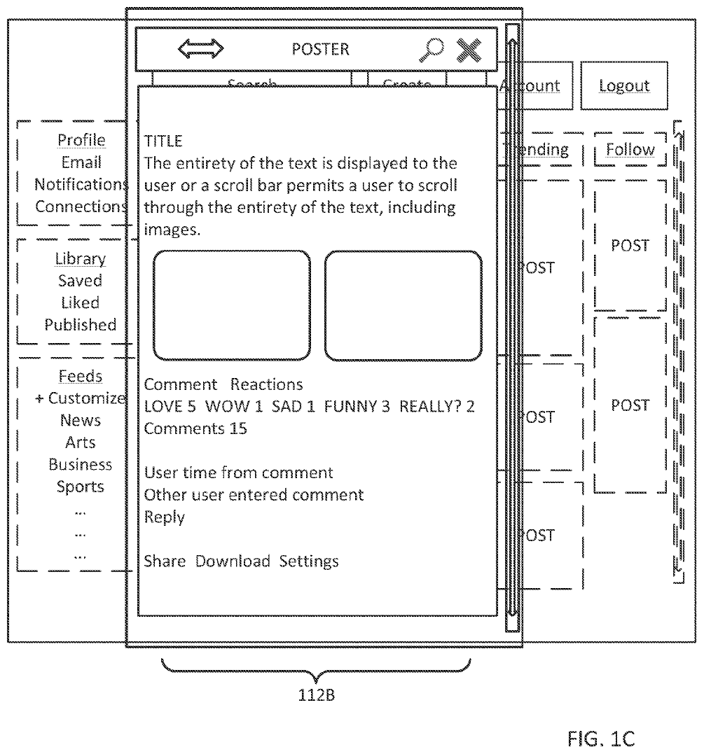

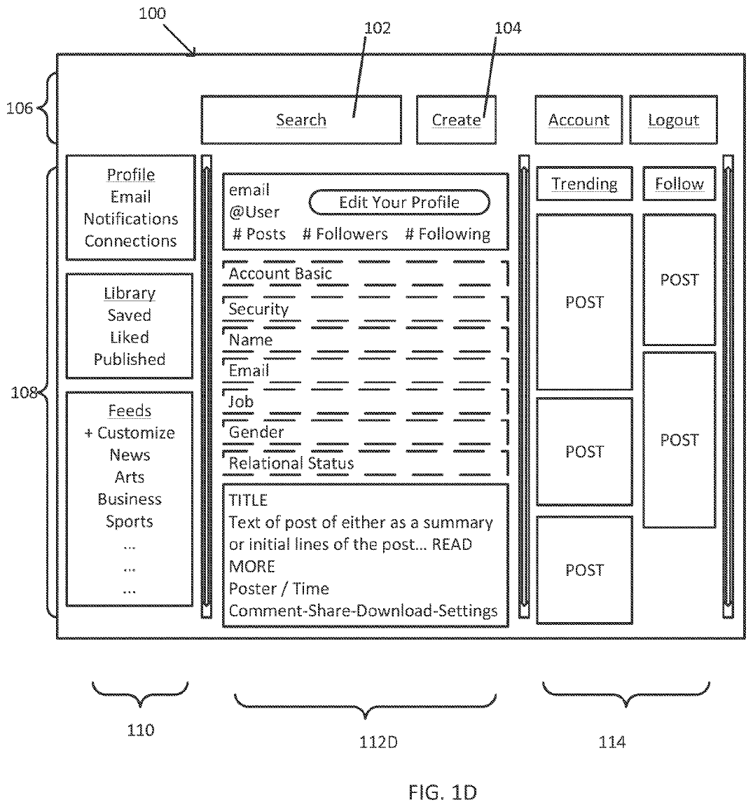

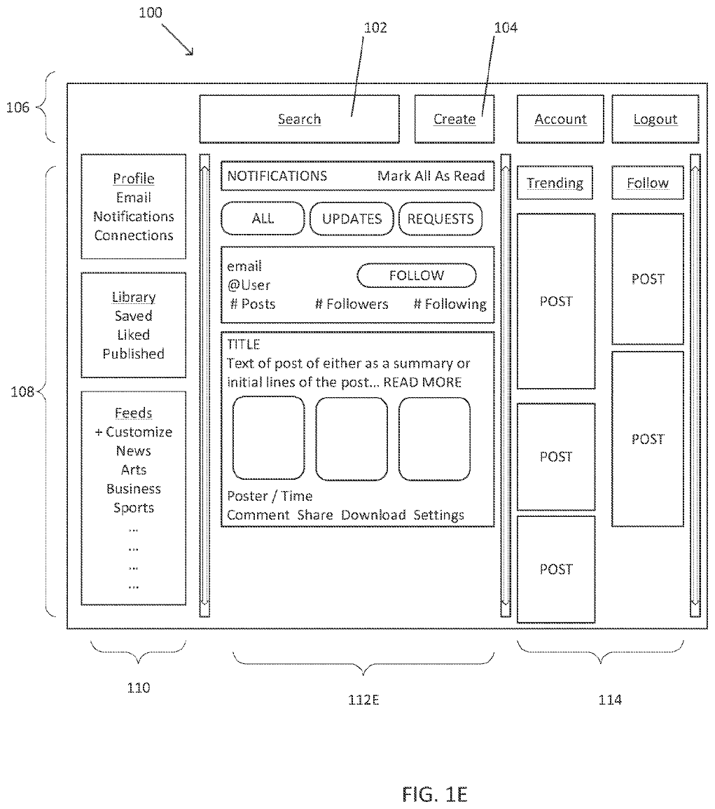

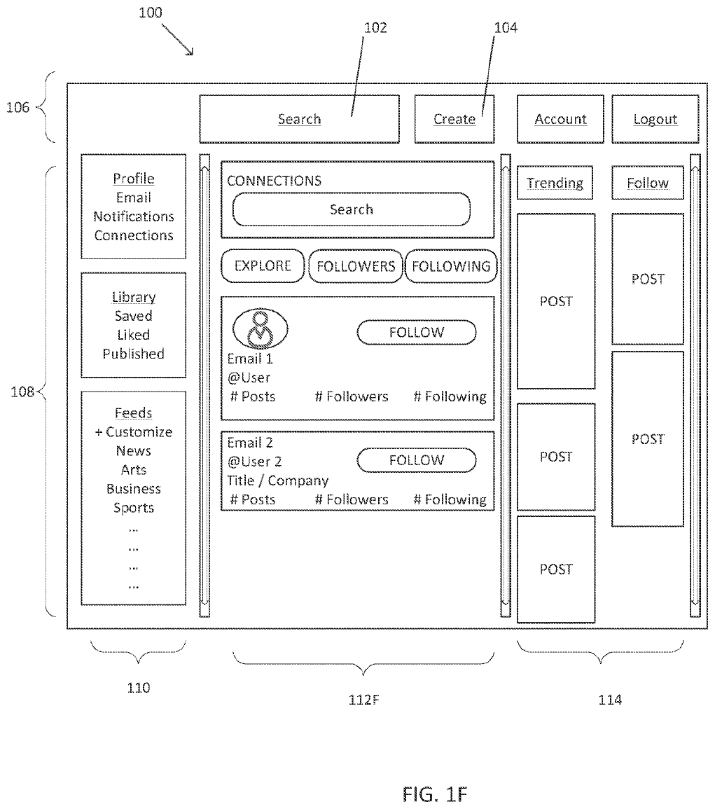

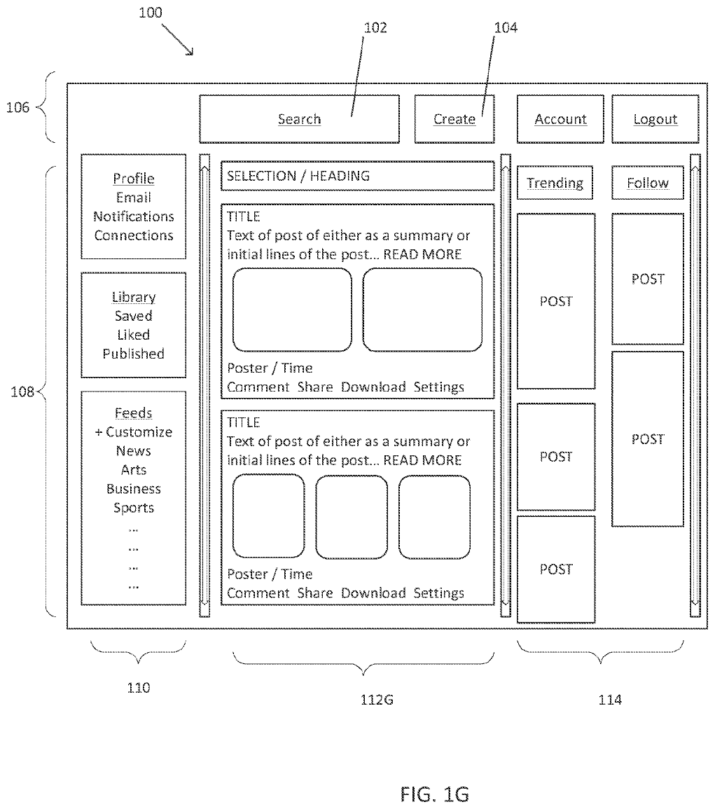

FIGS. 1A-1B illustrates an exemplary user interface according to embodiments described herein. As seen in FIG. 1A, the user interface may include a plurality of sections configured to provide the user input or output of content. The system is configured to permit the user to customize, selectively display, and/or collectively display information from one or more sources.

FIG. 1A illustrates an exemplary screen for displaying information to a user in a basic format. The user interface 100 may include a number of areas such as administrative area 106, summary area 110, main area 112, and feeds area 114. The display is configured to partition information from different sources and users in a way that a user observing the information can navigate between the information and obtain the desired information quickly and efficiently.

Exemplary embodiments of a user interface 100 includes an administrative area 106. The administrative area 106 may include one or more user interface locations, such as text inputs, buttons, links, drop down selections, and combinations thereof for a user to select for searching, adding, or managing content of the user interface and/or the account associated with the user interface. For example, as shown in FIG. 1A, an exemplary administrative area 106 may include a search bar 102 that permits a user to enter a search string and run a query on the content within the site. The exemplary administrative area may include one or more selection options 104. Selection options may include creating new content, adding or editing an account or user profile associated with the user interface, or logging out of the user interface.

Exemplary embodiments of a user interface 100 may include an active area 108. The active area may be used to display content, summaries, links, navigation inputs, and other information to the user. Exemplary embodiments may position the administrative area 106 of the user interface at a top portion of the user interface for displaying information to a user in a single location. Exemplary embodiments may position the activity area 108 below the administrative area 106. In an exemplary embodiment, the administrative area 106 may remain statically displayed on the user interface as other portions of the user interface, such as the active area 108 are relocated, such as through zooming in or out, and/or scrolling along a page.

Exemplary embodiments of the user interface 100 includes the summary area 110. The summary area 110 may be within the activity area 108. The summary area may include one or more section for displaying summaries of information accessible on the user interface. For example, the summary portion may include sections for displaying information having quick links to desired content. Quick links may include links to saved content, liked content, content published by the user. Quick links may include links to other content relating to specific criteria, such as user defined search criteria that may include specific search terms, flags, content subject matter, content creator, related users such as from those that showed interest in content through a user tag or comment, and combinations thereof. The summary area may comprise a control section having a plurality of selection options for the user to navigate content and display and/or control content display on one or more other content areas.

Exemplary embodiments of the user interface includes the feeds area 114. The feeds area 114 may include posts of users based on pre-defined user preferences. For example, the feeds area 114 may include one or more selection options for providing a list of desired content for the user to review. The feeds area 114 provides a list as well as a short summary or partial display of the associated content for the user to review and select. The feeds area may permit the user to select different feeds, such as the information that is currently trending or in which the user is following. A summary of available content is then provided in this space for user selection and high level review.

Exemplary embodiments of the user interface includes the main area 112. The main area may be configured to provide a high level summary of a plurality of posts, similar to the feeds area 114, or may display the full content of a selected post. For example, FIG. 1A illustrates an exemplary main area 112 displaying a plurality of posts in which each post comprises a summary of content of a more complete post, while FIG. 1B illustrates an exemplary main area 112A in which a post is selected and the entire content from the selected post is displayed in full to the user.

As illustrated in FIGS. 1A-1B, which of the plurality of display areas may include different content, such as summary or quick link selections for content, summaries of content, and main display of selected content. Each of the display areas may include separate navigation inputs, such as scroll bars for traversing or showing content within the category of content within a section that is not available for immediate display on a screen.

In an exemplary embodiment, the system is configured to take in an input from a user for selecting content related to one or more attributes of interest to a user. For example, a user may use the summary area 110 to select a quick link for selecting content related to a predefined criteria. The summary of content related to such a selection may be shown in the main area 112 and/or feeds area 114. The user may thereafter navigate the summaries to find content of specific interest. The user may then select content of specific interest by clicking on the content summary. Once selected, the entire post or content can be displayed in the main area 112A as illustrated in FIG. 1B. When expanded to complete content, additional information about the content may be displayed to the user. For example, the content creator may displayed. User inputs may also be displayed with the post. For example, quick links to add the content to a user's feeds, or to share with other users may be presented to the user for selection and input to the system. The additional information about the content may also include quick links to permit a user to navigate related content. For example, the content creator may include a quick link to permit the user to find other content from the same creator.

The system may include other inputs for changing the display of content. For example, as seen in FIG. 1B, the main content may include user inputs for displaying the main content in a larger area. When the icon is selected to enlarge the content, the content may expand to fill all or substantially all of the display window. For example, as seen in FIG. 1C, the main area 112A may enlarge to an enlarged main area 112B to encompass a larger portion of the display window. The enlarged main area 112B may encompass an entire screen display or a portion of the screen display. The enlarged main area 112B may include a user input for closing out the enlarged display and reverting the display to another display, such as those of FIG. 1A or FIG. 1B. In an exemplary embodiment, the enlarged main area 112B may be a pop out window or may be a display within the display.

As illustrated in FIG. 1C, the system may permit a user to provide various forms of related information to content provided through the system. For example, a user may enter in comments that may be displayed to one or more other users in relation to the original content in which the comment relates. The user may also provide a quick indication reaction about the content. For example, a user may like, love, and/or dislike content. The user may also be provided other reactions to content, such as sad, excited, astounded or astonished, humorous, confounded, or other emotional response. The system may provide the user one or more single input selections, such as through click button options for indicating a reaction to content. The content may then provide a summary indication of the users that have expressed different reactions.

The system may include user selections for controlling and filtering the content displayed to the user. For example, as seen in FIGS. 1A-1B, the first content area 110 may include a plurality of selections available to the user. The system may also include a third content area 112 for displaying content according to the selection of the user through the first content area 110. In an exemplary embodiment, as a user navigates and makes selections of the first content area 110, the displayed or available content provided in the third content area 112 is updated according to the selections of the user. In an exemplary embodiment, the system may include a second content area 114 that is unaffected by the input and output relationship between the first and third content areas.

FIG. 1D illustrates an exemplary embodiment in which a user has selected an input from a first content area for display in a third content area. The selection illustrated is for a user profile. As illustrated, a user may be provided a summary of their profile details when selecting a content filter for a user profile. In addition to user profile details, the third content area 112D may display content related to the user, such as content the user has followed, liked, commented on, created, posted, or combinations thereof. The displayed content in the third content area 112D may permit a user to provide input into the system, such as requesting to edit the user profile criteria. If a user selects to update a user profile, the system may present the user a template having a plurality of fields available to the user to create and populate a database for the user profile. For example, the fields in dashed boarders may expand from the user profile to permit the user to enter text, or make selections or other inputs through text fields, button selections, drop down menus, or other user input methods. Exemplary fields associated with a user profile may be a user name, profile name, profile image, account level, security setting, opt in or opt out selections, privacy settings, notification settings, email, phone, job title, employer name, residence city, residence state, residence zip code, gender, relationship status, school name, level of education, or other personal attribute the system may use to make selections and/or suggestions to a user and/or in which the system may use to match or search criteria and/or in which the user may wish to share with other users.

FIG. 1E illustrates an exemplary embodiment in which a user has selected an input from a first content area for display in a third content area. The selection illustrated is for the notifications associated with the user profile. As described herein, the user may make selections or connections within the system, such as by following users, following content based on different attributes, creating filters, creating searches, making connections with other users, chatting with other users, creating content, commenting on other content, and combinations thereof. The system may be configured to provide the user updates on different selections or connections associated with the user and the system. For example, the system may inform a user when new posts are available for content according to selected filters, search criteria, followings, etc. The system may also provide notices when new content is directed at a user, such as in receiving a communication from another user. In an exemplary embodiment, a user may make a user input selection from the first content area to provide content regarding notifications in the third content area 112E. The notifications may include posts or content regarding predefined criteria set by the user, posts or content directed at the user, such as through sharing by other users, requests directed at a user, chats or other communications for the user, and combinations thereof. The displayed content in the third content area 112E may permit a user to provide input into the system, such as confirming the content has been reviewed, or in selecting to accept a request or follow another user or content type based on a set of criteria. The third content area 112E may include other user input selections to further filter the displayed content. For example, the selected filter for notifications from the first content area 110 may further be filter based on all available notifications, new notifications, notifications concerning specific criteria or content type (such as following, feeds, searches, chats, etc.), notifications occurring in a specific time frame, outstanding requests from other users, and combinations thereof.

FIG. 1F illustrates an exemplary embodiment in which a user has selected an input from a first content area for display in a third content area. The selection illustrated is for the connections associated with a user profile. As described herein, the user may make connections with other users within the system. The user may follow other users, and thereby receive content generated by the other users. The user may review profile information of other users. The user may communicate with other users through posts, comments, chats, video feeds, audio feeds, and combinations thereof. As illustrated, a user may be provided a summary of user details of connections created between other users and the current user. The displayed content in the third content area 112F may permit a user to provide input into the system, such as confirming in selecting users or content in which to follow or deselect the option to follow (unfollow). The third content area 112F may include other user input selections to filter the displayed content or displayed connections. For example, the selected filter for connections may be through a search or criteria input made by the user. For example the selected filter for connections may be through a selection of one or more predefined criteria. The predefined filters may be in the form of buttons available to the user to select and filter the content. For example the predefined filters may be those to show the connections in which the user is following, the connections following the user, or in any combination of relationships or connections to the user.

FIG. 1G illustrates an exemplary embodiment in which a user has selected an input from a first content area for display in a third content area. The selection may include an predefined filter for selecting and displaying content. For example, the first content area may include selections for a user for filtering content based on an author, their own creates, posts at various stages (such as drafts verses posted), saved content, commented on content, liked content, content based on filter criteria such as subject matter, or other or any combination of attributes. Content meeting the filter criteria is then displayed to the user in the third content area 112G. As described herein, the user may make additional selections or filters regarding the filtered content, such as by selecting an individual item to expand the selected content or permit the user to create further filters, followings, etc. based on user inputs. In an exemplary embodiment, when a user makes a selection based on a predefined filter from the first content area, the third content area may present the user with the content according to the selection. The third content area may also include an indicator or heading according to the selected filter to indicate the relationship of the displayed content.

In an exemplary embodiment, the display system 100 according to embodiments described herein, may be used to receive content from various users and/or various sources and display the information for a user consumption and navigation in a user friendly way. The display system 110 may include three content areas. The content areas 110, 112, 114 include a combination of selection and display options. For example, a first display area 110 includes a selection area including predefined filters for displaying content in one or more other content areas. The predefined filters may be on any combination of filter criteria, such as subject matter, author, time, liked, relationships to other content, and combinations thereof. The predefined filters may be customized by the user and/or defined by the system for ease of selection. The predefined filters may be presented to the user in different user input/output methods, such as selectable links, drop downs, text input, etc. A second area 114 may include a combination of selection and display options. In this area, a predefined selection criteria may be implemented and a summary of results displayed to the user. The second content area may use a predefined selection criteria set by the user, programed by the system architecture, and/or related to one or more other content areas. For example, the second content area 112 may provide a summary of content that meet predefined selection criteria selected by the architecture. For example, the content area may include a summary of content that is currently trending or identified as followed by the user. The predefined content area may include a combination of predefined criteria defined in the system architecture and having a user selection. For example, the system may permit the selection between a limited option of display summaries, in which the user provides a user selection 114 for displaying a summary of content in the content area 114. The second content area 114 may also or alternatively display a summary of content related to one or more other content areas. For example, the second content area 114 may include a summary of content from a selection from the content area 110 including selection options. The third content area 112 may include a display of selected content. For example, the selected content may include a summary of content meeting the criteria of one or more other user inputs, such as through selection from content area 110 or may display an entire content page from a selection from a user selection from one of the content areas 110, 112, 114. The main or third content area 112 may be used to consume the majority of content, while the first and second content areas may be used as alternative selection displays for providing a user a convenient and easy way to navigate between different selection criteria. In addition to the content areas 110, 112, 114, the system may include an administrative area for additional system functionality, control, and/or selection.

In an exemplary embodiment, one or more areas of content areas may be independently navigated through independent scroll features. For example, each content area may include a separate scroll feature 116A, 116B, 116C, such that each scroll bar controls a dedicated and separate content area. In an exemplary embodiment, the page scroll feature (not shown) may be used to control one of the content areas, while separate scroll features are provided for other content areas. In an exemplary embodiment, the page scroll feature (not shown) may be used to control a scroll of an entire screen, such that all content areas are scrolled together in relative position, while each individual content area may be separately controlled through its own dedicated scroll feature.

In an exemplary embodiment, one or more areas of content may include content having video and/or sound recordings. In an exemplary embodiment, the content areas may include summary areas that display placeholders or still images of the video and/or sound recording. When the summary content is displayed to the user in summary form, the different videos and audio should not be played as the use of data transmission would be very large to stream data for all content to the same user and the audio would overplay and become inaudible to the user. Therefore, in the summary content display, audio feeds may be indicated by an icon, but not played, and video feeds may be represented by an icon, another icon different from the audio icon, and/or a still image from the video. When the summary content is selected through a click on the summary content, the entire content may be displayed to the user and the video and/or sound recording played to the user in the full display mode according to embodiments described herein. In an exemplary embodiment, a user may be able to play the video and/or audio in the summary display configuration. For example, a user may hover over an image or icon representing a video and/or audio recording. When the user input device is detected over a predefined location representing the recording, the single recording associated with the user input (i.e. proximate to the hover input) may be selected and played by the system. Therefore, the system may be configured to play a single recording based on a user input even though the content is still displayed in a summary fashion. In an exemplary embodiment, a hover input may be a finger or object positioned proximate to or next to a user input display screen (i.e. touch screen), or in the movement of another input device, such as a mouse positioned over or adjacent the selected object. In an exemplary embodiment, the selection may be detected by the object over the object to be selected. In an exemplary embodiment, the selection may be detected by the object in proximity to the object to be selected. For example, the mouse selection or hovered finger may be positioned below or adjacent the object to be played or in a corner thereof, such that the display is unobstructed by the input method. In an exemplary embodiment, the object may play through for an entire duration regardless of the continued position of the input method. For example, a hover may start a recording, but the hover may move away from the object to permit unobstructed viewing. In an exemplary embodiment, a second input event, such as a second hover input may be used to pause or stop the recording. In an exemplary embodiment, the object may play for a duration in which the selection event is maintained. For example, when the hover input is removed, the recording may be paused or stopped.

In an exemplary embodiment, the system may be configured to display an entire content area associated with a user selection of a summary content. For example, when a user selected by touching or clicking on a displayed content in the summary form in either content areas, the content may expand to show an entire content associated with the selection. The expanded content may then be scrolled or consumed. Additional options, user inputs, or selections may be associated with the expanded content.

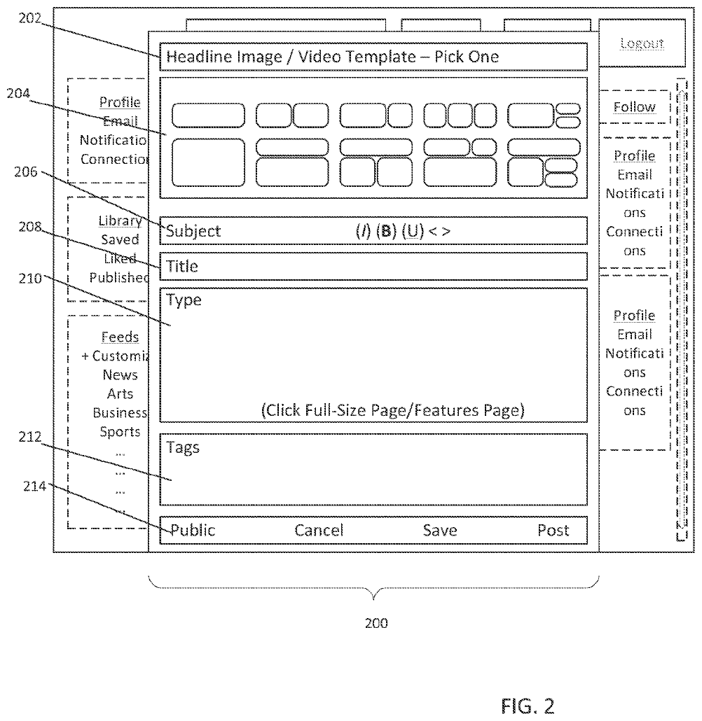

In an exemplary embodiment, the system is configured to permit a user to create unique content for display within the system. The user may select or provide a user input to create new content. For example, from the administrative area 106, the user may select to create content by selecting user input 104. FIG. 2 illustrates an exemplary user interface for creating content 200. The user interface for creating content provides instructions 202 regarding the template selection process for ease of creation. The user interface for creating content also provides a selection option for selecting a template. The template may include a positioning of images/video, and/or written text. The templates may permit the inclusion of multiple images and/or videos within the same posting. In an exemplary embodiment, the templates are provided for easy display in a larger and condensed or summary format for display within the different content areas according to embodiments described herein. The content creation user interface provides other user input options, such as, for example, a subject 206, title 208, type 210, tags 212, and other features and/or commands 214. The combination of the subject, title, type, tags, and combinations thereof may be used for improved searching of the content by the user or other users of the system.

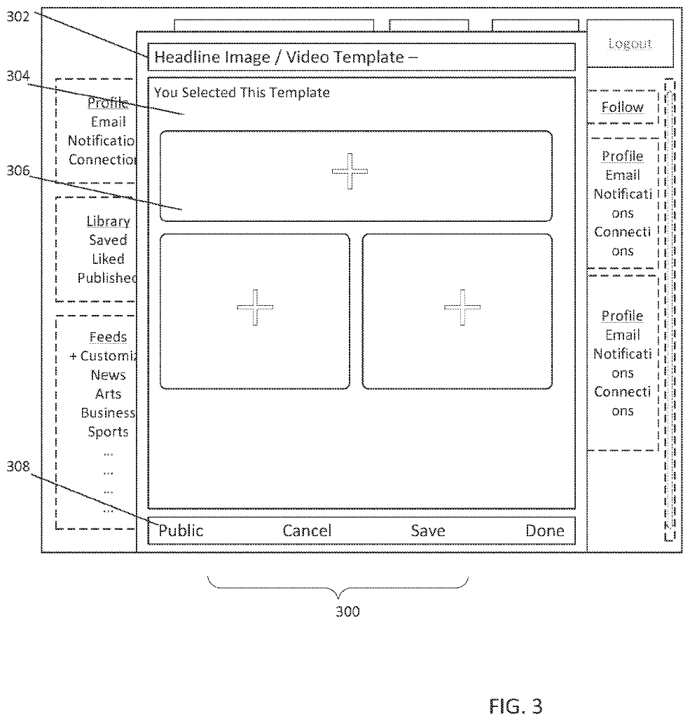

FIG. 3 illustrates an exemplary user interface for populating the areas of a selected template as provided by a user through user interface of FIG. 2. The user interface for content creation according to a selected template 300 may include a headline or video template title 302, a selected content area 304, a selection of images and/or videos 306 according to the frames available in the selected template, and other user input selections 308.

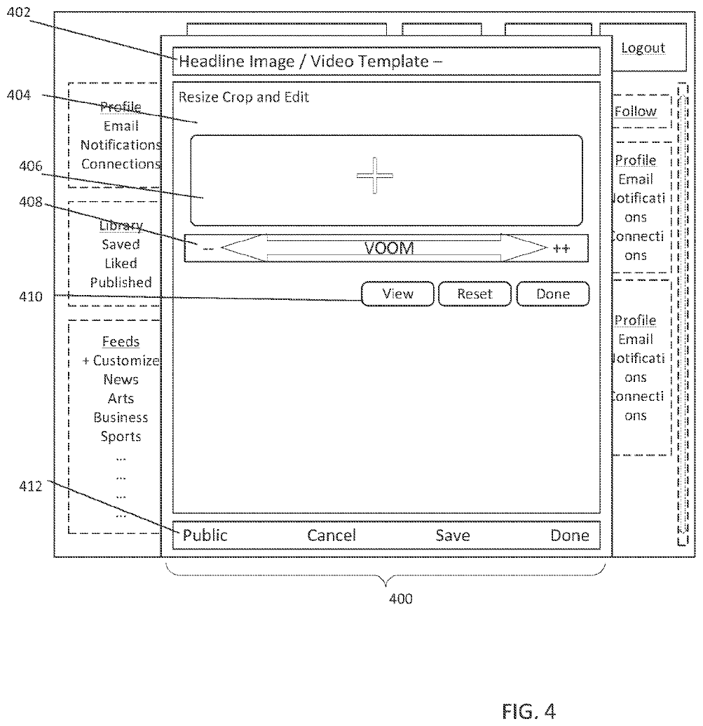

FIG. 4 illustrates an exemplary user interface for customizing an image and/or video that is selected for inclusion within a template position of the user interface from FIG. 3. The user interface for image editing 400 includes a selected template 402, input area 404, display of the selected image 406, annotation features 408, control features 410, and other user inputs 412. In an exemplary embodiment, the image may include a still image or a video image. In an exemplary embodiment, the user may reposition, enlarge, shrink, crop, or otherwise manipulate an image for use within the post. In an exemplary embodiment, a user input to manipulate an image may be applied to each frame within a video stream. In an exemplary embodiment, a user may provide an input to manipulate an image associated with an individual frame within a video stream. The system may be configured to display the user altered images within the video stream as manipulated by the user. The system may be configured to alter adjacent images around the user manipulated image within the video stream to transition between an unaltered video stream to and from the user manipulated image. For example, if a user zooms in on an image on a single frame of a video stream, the system may be configured for a set number of frames before or after the user manipulated image to proportionally zoom each sequential frame so that the altered video transitions from an unaltered video stream to the user manipulated image within the modified video stream in a sequential and smoother fashion. The number of frames for a transition may depend on the user manipulation. For example, minimal zoom may use fewer transitional frames than a greater zoom. In an exemplary embodiment, the system may be configured to permit the user to indicate a frame or image of a video stream for display in the summary or still representation of the video image. In an exemplary embodiment, the system may select the first frame as the still image for representation of the video stream.

The system may be configured to receive text associated with the post. The system may be configured to summarize the text of the post, such as by showing the first portion of text of a post within a summary display of the content. The system may also be configured to automatically generate a summary based on the text of the content. The system may also be configured to receive a summary text from the user during content generation. The summary text may be limited to a number of characters for display in the summary display, and replaced by the full content when a user selects viewing of the full content.

FIG. 5 illustrates an exemplary user interface according to embodiments described herein. FIG. 5 illustrates an exemplary embodiment having a plurality of content areas. Content areas illustrated in FIG. 5 may be similar to content areas displayed in FIG. 1A. Additional content areas may be provided in addition to or alternatively to those provided in FIG. 1A. For example, content area for filtering content may be subdivided such that a first filter area 14 is provided based on a first set of criteria, such as, for example, content types or categories and a second filter area 32 is provided based on another set of criteria, such as subject matter, user selections, etc. A content area 30 may be provided for displaying selected content. A content area 34 may be provided to display social functionality or additional or alternative functionality beyond content display or selection. A content area 12 may be included for content creation.

As shown, the content areas may include two content summary areas and a display content area. The content area having a user selection may include predefined filters for user selection similar to content area 110 described herein. For example, the predefined filters may be grouped and displayed in user feeds 16 and pages 18. The content display area 30 may be similar to content area 112 of FIG. 1A in which summary content may be displayed to a user and/or main content displayed to a user. In an exemplary embodiment, the system may be configured to display summary content in content area 30 and display entire content associated with a selected one of the plurality of content displayed in the summary content within an enlarged display area or separate window similar to the user interface displayed in FIG. 1C.

The exemplary embodiment of the user interface displayed in FIG. 5 includes a content area directed to a social interaction between users. For example, the system may support friends, chats, instant messaging, or other forms of social engagement between users. The content area may therefore provide summary information or easy selection by a user to navigate social features associated with the system. In an exemplary embodiment, the content area associated with social engagement may be a selectable predefined content selection for display in the second content area 114 of FIG. 1A.

As seen in FIG. 5, the user interface may include a plurality of sections configured to provide the user input or output of content. The system may be configured to permit the user to customize, selectively display, and/or collectively display information from one or more sources.

In an exemplary embodiment, the user interface includes a first section 12 for creating content. The first section may include a plurality of options in which the user may create content. For example, as displayed, the user may create a blurb, a page, an image, a video, or an event. Any combination of different content objects may be displayed for the user to create. The different user contents may define different content attributes. For example, a blurb may be a short text string that permits instant notification to other users, while a page may permit a layout design including, but not necessarily limited to, images, pictures, videos, text, font and script designs, headings, content, among other objects combined together in a unique or predefined display configuration. The page may include one or more template options for displaying the entered content. Images and videos may permit a user to navigate to files stored on an electronic device and upload the files to the platform for display to other users. Images and videos may permit the user to use a camera of an electronic device used to display the user interface and/or coupled to an electronic device used to display the user interface to retrieve an image or video and create a file to be uploaded to the system and displayed to other users of the system.

In an exemplary embodiment, the user may be permitted to create different types of content. The content may be text, images, video, or other data packets of information that may be displayed on one or more areas within the system. For example, if a user is chatting with another user, the text used to send or receive a chat can be posted within a separate portion or window of the system for the conversation between the selected users. As another example, a user may post a blurb that simply adds content to the displayed information section described herein. The content then is simply displayed within a list or already created/generated webpage of the system.

In an exemplary embodiment, the user may be able to create a separate page. The creation of a page may reside within the larger domain of the system. When a page is created within the system, the page attributes can be directly added to the database for immediate searching. In conventional search engine systems, the search engine periodically crawls the internet looking for different domains and then traversing through pages to navigate and catalog the pages of the internet. A new page may therefore take some time to be identified by a search engine. The relevance of the created page to the search engine may also not be immediately known. Exemplary embodiments described herein may permit the creator of the content to describe or tag the content and make the page immediately accessible or available for searching. Exemplary embodiments may therefore limit higher level domains as created websites reside within the domain of the system.

In an exemplary embodiment, the created website may have attributes of conventional websites. The created website may also have additional components specific to the environment of the system. In an exemplary embodiment, the system may include an icon or indicator on a website to share the page. The system may be configured to receive an input from a user to indicate one or more other users in which to share the page. The other users may then receive a notification and access to the page. The other users may have a feed or shared section in which the page may be displayed or identified. The other users may have a communication interface for providing access to the page, for directly displaying the page, for directly displaying a portion of the page, or to indicate a page is available for viewing. For example, the section for retrieving user interactions described herein may include a section for shared pages that may display one or more pages, portions of pages, or descriptions of pages for the user to select and/or view.

In an exemplary embodiment, the user interface includes a content area, a second section 30, used to display information to a user. The displayed information may include portions of information received or posted by the user and/or other users to which the user is or is not connected. The displayed information within the second section 30 may use the different content attributes of the different content types to define a specific display for each of the different content types. The display may therefore provide a shortened version or the entire version of an entered content depending on the content type. The second section 30 may display all of the content associated with the user or may display a subset of the content associated with a user. The display section may include different additional user exchange indicators associated with one or more or each of the displayed content pieces. For example, an exchange indicator may include an author or source of the displayed content. An exchange indicator may include a number or icon to retrieve comments associated with a specific displayed content. An exchange indicator may include an icon or user input for sharing the displayed content with others. An exchange indicator may include a settings option to change the display, notifications, or other attribute associated with the displayed content or an attributed associated with the displayed content.

In an exemplary embodiment, the displayed content may be filtered. The system may include a pre-defined filtered section to select content based on a content type 14. The pre-defined filtered section based on content type 14 may mirror similar options as the first section 12 for creating different content type. Therefore, as illustrated, the pre-defined filtered section may include a selection for filtering on blurbs, pages, photos, videos, or events. The pre-defined filtered section may also include a selection of all that may be used to compile a single feed of the various content types. The system may permit a user to select one or more of the pre-defined filter types so that a user may display different combinations of content types within the display.

In an exemplary embodiment, the user interface may also include a feeds section 16. The feeds section may permit a user to select information based on one or more attribute. A feed may be defined as information originating from a specific source. A feed may be a page, or specific content type. A feed may be defined as information including one or more identifiers or related attribute, such as keywords, authors, subject matter, category, content type, etc. The keyword may be found within the content or may be added as a tag to the content by the user posting the content or the system. The keyword may identify content subject matter, such as, for example, celebrities, specific celebrities, pets, childcare, etc. The feed may include any combination of attributes used to distinguish and identify a specific subset of information, such as by subject matter, source, time, content type, etc.

In an exemplary embodiment, the user interface may also include a section for retrieval of user interactions with the system 18. The user may interact with the system by saving pages (or other content), publishing pages (or other content), liking pages (or otherwise indicating a like or dislike for content of the user or another user), etc. The retrieval section may include one or more selection locations for a user to retrieve or display the work associated with the user. The work may be content in process of being created, content that has been posted or provided to the system, and combinations thereof.

In an exemplary embodiment, the user interface may include a notifications section 24. The notifications section may include reminders of work to complete, indications that new content has been created and/or is available to the user, an alert according to predefined preferences created by the system and/or user, notification that another user is either or not connected to the system, etc. The notifications section may be used to expand the information associated with the notification upon an input received from the user.

In an exemplary embodiment, the user interface may include a section to indicate present conversations 26. The present conversations may include text, image, and/or video exchanges with one or more other users. The conversations section may include different combinations of exchanges with different combinations of different users. For example, an exchange may be a text exchange between a single user, or a video exchange among multiple users. The conversations may be in real time or may be delayed and received by a user when they are online.

In an exemplary embodiment, the user interface may include an indication of other users in which the user is connected 28. The connection may include any user also using the system or configured to communicate with the system through another interface, such as other social media sites. The user interface may indicate a current status of the user with regard to the system, such as online or offline. The user interface may indicate a most recent exchange with the user or action of the other user. The user interface may display an image associated with the other user. The user interface may display a name associated with the other user.

In an exemplary embodiment, the user may search through a search interface 20. The search interface may include a text portion for receiving text input from a user, such as search terms or a search string 20. The search interface may also include a filter option 22 to limit search results to specific attributes of the system, such as most recent, content type, etc.

In an exemplary embodiment, the system may be configured to permit a user to add information to the system. The system may therefore receive an input from the user indicating a content type to be added. The input may be through a selection from, for example, the content creation section 12 of the user interface. Once the content type is indicated, the system may provide a user interface template for receiving desired information associated with the content type. For example, if the content type is a blurb, the user interface may include a text box that limits the number of received characters to a predefined maximum. The system may be configured to receive an input of the user associated with the status of the entered content. For example, the user may indicate the content to be saved for further modifications, review, etc. or may indicate that the content is ready to publish. If the content is indicated as to be saved, the system may save the content locally to the electronic device used to display the user interface or may upload a packet of data associated with the received content and save the content to a database. The saved content may be indicated as saved and not available for distribution. If the content is indicated as published, the content may be saved as a single data package and sent to a remote server for storage on a database. The system may be configured to validate the data package. Validation may include a check of the information to determine whether the data format meets a predefined set of requirements associated with the data type (such as, for example, data size limitations). The validation may include authorizing a source of the information, to verify an author and/or confirm the author has appropriate permissions to create and post the information. For example, an authentication may be performed before posting information and associating the information with a user to determine whether the source of the information is from the user and not another user. The system may be configured to save the data package to a database.

In an exemplary embodiment, the system may be configured to permit a user to add information to the system. The system may be configured to report that a data package has been received by a user. The data package may include one or more attributes identifying the data package. The one or more attributes may include a source of the data package, the content type, the date and/or time of data package upload, a subject matter of the data package, etc. The system may be configured to display all or a portion of the data package to another user. The system may be configured to display information related to the data package based on the type of content contained in the data package. For example, if the data package is a blurb, the system may be configured to display the entire blurb. If the data package is a page, the system may be configured to display a portion of the page or information related to the page to provide a condensed summary or display of the page to a user. Before posting a data package or information related to the data package, the system may be configured to search the other displayed content items to remote or prevent posting of duplicate information. For example, if a user creates a page, and another user shares the same page, the content will be the same. Therefore, if a third user is linked to both the page creator and the other user that shared the page, the page or information associated with the page would be displayed only once to the third user.

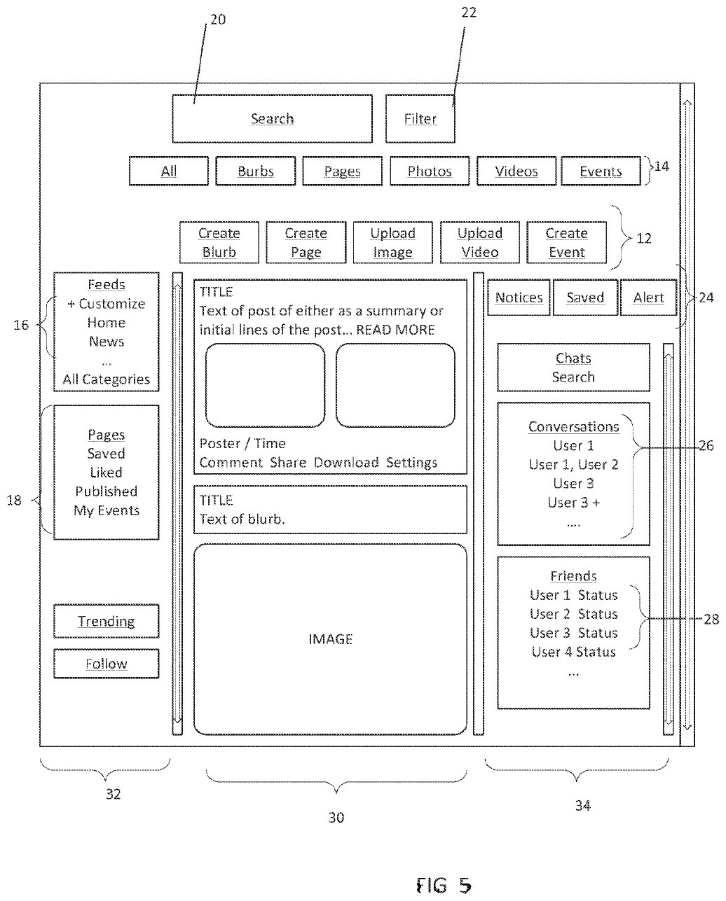

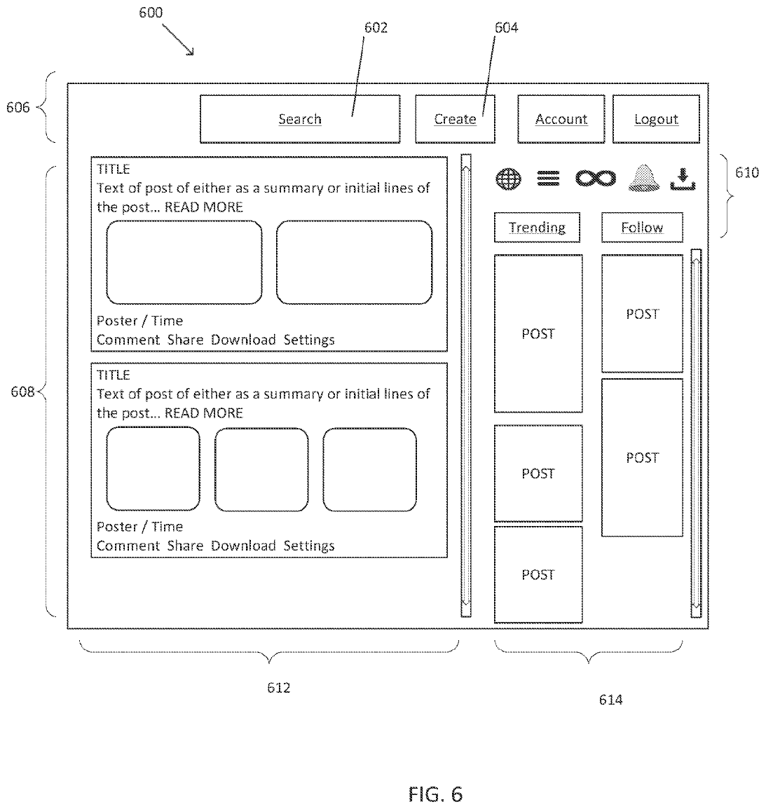

FIG. 6 illustrates an exemplary user interface according to embodiments described herein. FIG. 6 illustrates an exemplary embodiment having a plurality of content areas. Content areas illustrated in FIG. 6 may be similar to content areas displayed in FIG. 1A. Additional content areas may be provided in addition to or alternatively to those provided in FIG. 1A. For example, content area for navigating and/or controlling the display of information of other content areas may be represented in different form, such as through icons, and may be repositioned on the page. A content areas may also be linked in different ways as described with respect to FIGS. 1A-1G and elsewhere herein.

FIG. 6 illustrates an exemplary user interface according to embodiments described herein. The exemplary user interface 600 may include a plurality of sections configured to provide the user input or output of content. The system is configured to permit the user to customize, selectively display, and/or collectively display information from one or more sources.

FIG. 6 illustrates an exemplary screen for displaying information to a user in a basic format. The user interface 600 may include a number of areas such as administrative area 606, summary area 610, main area 612, and feeds area 614. The display is configured to partition information from different sources and users in a way that a user observing the information can navigate between the information and obtain the desired information quickly and efficiently.

Exemplary embodiments of a user interface 600 includes an administrative area 606. The administrative area 606 may include one or more user interface locations, such as text inputs, buttons, links, drop down selections, and combinations thereof for a user to select for searching, adding, or managing content of the user interface and/or the account associated with the user interface. For example, as shown in FIG. 6, an exemplary administrative area 606 may include a search bar 602 that permits a user to enter a search string and run a query on the content within the site. The exemplary administrative area may include one or more selection options 604. Selection options may include creating new content, adding or editing an account or user profile associated with the user interface, or logging out of the user interface.

Exemplary embodiments of a user interface 600 may include an active area 608. The active area may be used to display content, summaries, links, navigation inputs, and other information to the user. Exemplary embodiments may position the administrative area 606 of the user interface at a top portion of the user interface for displaying information to a user in a single location. Exemplary embodiments may position the activity area 608 below the administrative area 606. In an exemplary embodiment, the administrative area 606 may remain statically displayed on the user interface as other portions of the user interface, such as the active area 608 are relocated, such as through zooming in or out, and/or scrolling along a page, or as content displays change within the active area 608.

Exemplary embodiments of the user interface 600 includes the summary area 610. The summary area 610 may be within the activity area 608. The summary area may include one or more section for displaying summaries of information accessible on the user interface. For example, the summary portion may include sections for displaying information having quick links to desired content. Quick links may include links to saved content, liked content, content published by the user. Quick links may include links to other content relating to specific criteria, such as user defined search criteria that may include specific search terms, flags, content subject matter, content creator, related users such as from those that showed interest in content through a user tag or comment, and combinations thereof. The summary area may comprise a control section having a plurality of selection options for the user to navigate content and display and/or control content display on one or more other content areas. As shown, the quick links may be represented as icons or visual representations associated with the content they are intended to represent. As illustrated, the exemplary icons represent content selections for home (or original content display criteria), feeds, connections, notifications, downloaded or saved content, trending, and following.

Exemplary embodiments of the user interface includes the feeds area 614. The feeds area 614 may include posts of users based on pre-defined user preferences. For example, the feeds area 614 may include one or more selection options for providing a list of desired content for the user to review. The feeds area 614 provides a list as well as a short summary or partial display of the associated content for the user to review and select. The feeds area may permit the user to select different feeds, such as the information that is currently trending or in which the user is following. A summary of available content is then provided in this space for user selection and high level review.

Exemplary embodiments of the user interface includes the main area 612. The main area may be configured to provide a high level summary of a plurality of posts, similar to the feeds area 614, or may display the full content of a selected post. For example, FIG. 6 illustrates an exemplary main area 612 displaying a plurality of posts in which each post comprises a summary of content of a more complete post. However, the main area 612 can display full content similar to the exemplary main area 112A illustrated in FIG. 1B in which a post is selected and the entire content from the selected post is displayed in full to the user.

As illustrated and described herein, each of the plurality of display areas may include different content, such as summary or quicklink selections for content, summaries of content, and main display of selected content. Each of the display areas may include separate navigation inputs, such as scroll bars for traversing or showing content within the category of content within a section that is not available for immediate display on a screen. Each of the display areas may be related or linked such that user inputs or navigation within one of the content areas effects the display of one or more other of the content areas. The content areas may also be independently manipulated to provide further independent control of the system.

In an exemplary embodiment, the system is configured to take in an input from a user for selecting content related to one or more attributes of interest to a user. For example, a user may use the summary area 610 to select a quicklink for selecting content related to a predefined criteria. The summary of content related to such a selection may be shown in the main area 612 and/or feeds area 614. The user may thereafter navigate the summaries to find content of specific interest. The user may then select content of specific interest by clicking on the content summary. Once selected, the entire post or content can be displayed in the main area 612. When expanded to complete content, additional information about the content may be displayed to the user. For example, the content creator may displayed. User inputs may also be displayed with the post. For example, quicklinks to add the content to a user's feeds, or to share with other users may be presented to the user for selection and input to the system. The additional information about the content may also include quicklinks to permit a user to navigate related content. For example, the content creator may include a quicklink to permit the user to find other content from the same creator. The selection of the quicklink may update the content of either the feeds area 612 and/or the main area 612 to correspond to the selection made by the user. In an exemplary embodiment, the main content area 612 may include a forward and back navigation option, such that the user may navigate forward and backward through the content displayed in the main content area. The forward and back navigation of the main content may be independent of the summary area and feeds area.

Exemplary embodiments are provided herein to permit a user to more easily and efficiently navigate through content displayed to a user. Exemplary embodiments may therefore provide combinations of static content within different content areas and dynamic content that is linked between different content areas such that a user can navigate within content more easily.

Exemplary embodiments described herein include methods for navigating content. For example, a first static content area may be displayed and represented to the user. The first static content area may provide selection criteria for a user to choose different content of interest to the user. Exemplary first static content area may, for example, include content areas 610 of FIG. 6, content area 110 of FIG. 1A, content area 32 of FIG. 5, and combinations thereof, or otherwise apparent from the description herein. The first static content area may be configured to display to a user as the user navigates through content within other content areas or as the user makes selections from the first static content area. In an exemplary embodiment, the static content area may include quick links that permit a user to make a single input selection and select a plurality of content comprising related criteria corresponding to the selection. The quick links may have defined criteria corresponding to a category (such as news, sports, entertainment, etc.), action of the user (such as liked, saved, published, followed, etc.), an object (such as author, topic, etc.), tags, among other exemplary criteria. In an exemplary embodiment, the first static content area may include an independent navigation input, such as a scroll input. The orientation and layout of the first static content area may be positioned by the user and may be retained despite selection or other input by the user within the other content areas. For example, the user input through the first static content area may drive or unidirectionally affect the content of one or more other content areas, but may not itself be effected by selection of the user in these other content areas.

The method may include receiving a first input from the user through a user input indicating a selection of one of the quick links represented in the first static content area. Upon selection of the user of an input through the first static content area, the user interface is updated, such that a second content area of the user is updated and displays content associated with a selection of the user corresponding to the first input. As the second content area of the user is updated, the first static content area may remain static or the same as before the second content area was updated. The user may reposition or orient the first static content area (such as by scrolling), while the second content area remains unaffected. A user may make another selection within the first static content area, such as by clicking another of the quick links. Upon selection of the user of the second input through the first static content area, the user interface is updated again, such that the second content area of the user is updated and displays content associated with the selection of the user corresponding to the second input. The display of content associated with the selection of the user corresponding to a specific input may include a summary or list of content for further review and selection of by the user.

The method may include navigating the second content area by the user, such as by scrolling through displayed content, and/or by making a user selection of a third user input. The third user input may be through hovering, clicking, double clicking, tapping, or other input mechanism for indicating a selection of content within the second content area. As illustrated in exemplary embodiments herein, the second content area may be as illustrated by area 34 of FIG. 5, area 114 of FIG. 1A, area 614 of FIG. 6, or as otherwise described herein or supported by the disclosure herein. The second content area may display a plurality of summary content associated with the user input from the first content area. The method may include receiving a third user input from the user indicating a selection of a specific one of the plurality of summary content within the second content area. Upon the third user input, the user interface may be updated, such that a third content area is updated to illustrate a full display of content associated with the summary content of the specific one selection by the user. Upon updating of the third content area, the second and first content areas may remain the same as before the updating such that the first and second content areas remain static and simultaneously represented to the user as the third content area is updated and displayed. The second content area may therefore be unidirectionally linked to control the display of content on the third content area.

The method may include navigating the third content area by the user, such as by scrolling through displayed content, and/or by making a user selection of a fourth user input within the third content area. In an exemplary embodiment, the second content area is unidirectionally linked to the third content area. In this case, the selection of a user through the fourth user input may update the content within the third content area corresponding to the further user input, while the first and second content areas remain unaffected. In exemplary embodiment, the second content area may be bi-directionally linked to the third content area, such that a selection by the user through a further user input may update the content of the second content area. This may occur if the user makes a quick link selection within the third content area indicating a selection of content corresponding to a group or category of information (such as, for example, content related to an author, content related to a subject, content having the same tag(s), etc.) Therefore, the selection of the user through a fourth user input may update the content displayed within the second content area to display a summary of content related to the fourth user input.

Exemplary embodiments may be used by the user to navigate between displays that include related content without having the user switch between screens or use the “back” feature to move back and forth to review related content. Instead, exemplary embodiments may be used to display a plurality of content options to be navigated by the user, while simultaneously displaying the associated content corresponding to a single selection of one of the plurality of content options selected by the user. The user may then update the display and navigate between the plurality of content options without having to navigate backwards, but instead merely provide additional user inputs corresponding to different selections of individual ones of the plurality of content options.

The method may include displaying and defining an original display of the content areas before receiving a first input from the user. For example, the system may be configured to display a first configuration of the first, second, and third content areas. In this case, the first content area may remain static and display a desired combination of quick links for user input to navigate and/or control content displayed within either of the second or third content areas. The second and third content areas, may be configured to display a predefined selection before a specific selection is made by the user in the instant user of the system. For example, the predefined selection may be user set upon a configuration of the user preference, and/or may be system defined by an administrator or system user. In an exemplary embodiment, the predefined selection of the second and third content areas may be summary of content associated with one or more of the quicklinks provided in the first content area. For example, the first content area may provide quicklinks for content that is currently trending, or for specific feeds defined by the user. The second content area may be preconfigured to display the summary of content associated with the content currently trending, while the third content area is preconfigured to display the summary of content associated with the specific feeds defined by the user. Other summary content may also be displayed to the user, such as notifications, connections, etc. The user may thereafter provide an input to the system according to the system and methods described herein to update the content displayed in the first, second, or third content areas.

In an exemplary method, a system is provided to display a user interface to a user, such as through a web browser or on a downloadable application on a user device. The method includes displaying a plurality of content to the user. The display of the plurality of content includes an initial display having a first content area, a second content area, and a third content area. The first content area defining a plurality of selection options corresponding to content having related criteria. Exemplary related criteria may include feeds, connections, notifications, and selected content. The method includes receiving a first input from the user selecting one of the plurality of selection options through the first content area. Upon the selection, the second content area is updated with content associated with the related criteria of the selection. For example, if the user selects feeds, the second content area may display a plurality of content related to one or more feeds defined by the user. The system may also display options for identifying the feeds of the user, and/or adding or removing the feeds defined by the user. For another example, if the user selects connections, the second content area may display a plurality of connections of the user. The content area may also update to provide additional selections available to the user, such as by selecting a sub-criteria, such as specific connections. Such sub-criteria may, for example, include the connections being followed, following the user, for searching, or identified by a specific category (such as friend, family, etc.). For example, if notifications is selected, then the recent updates may be displayed. Additional user inputs may also be provided, such as to display all notifications, provide updates, provide follower requested, etc. The notifications may provide content to the user, such as when someone has shared a post, requested to follow the user, accepted a follower request, or when new content is posted.

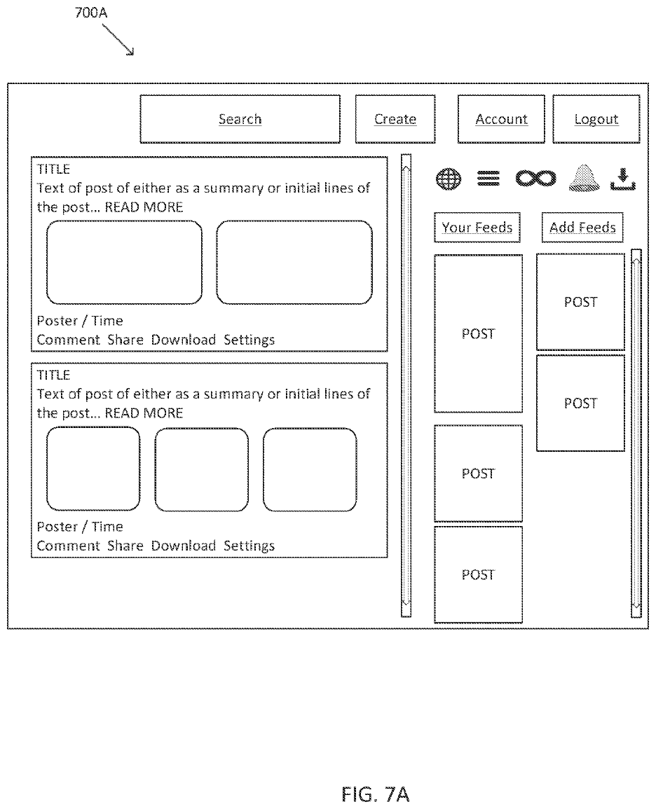

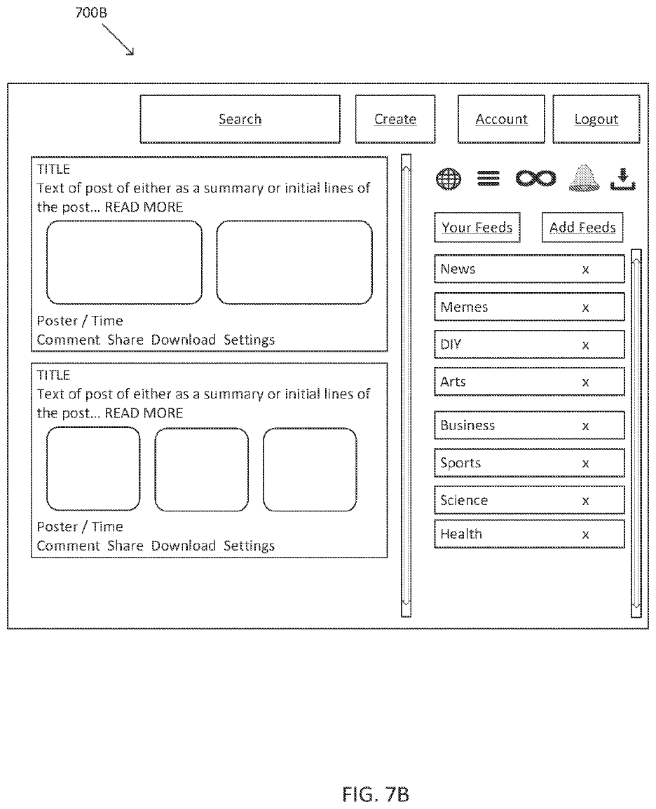

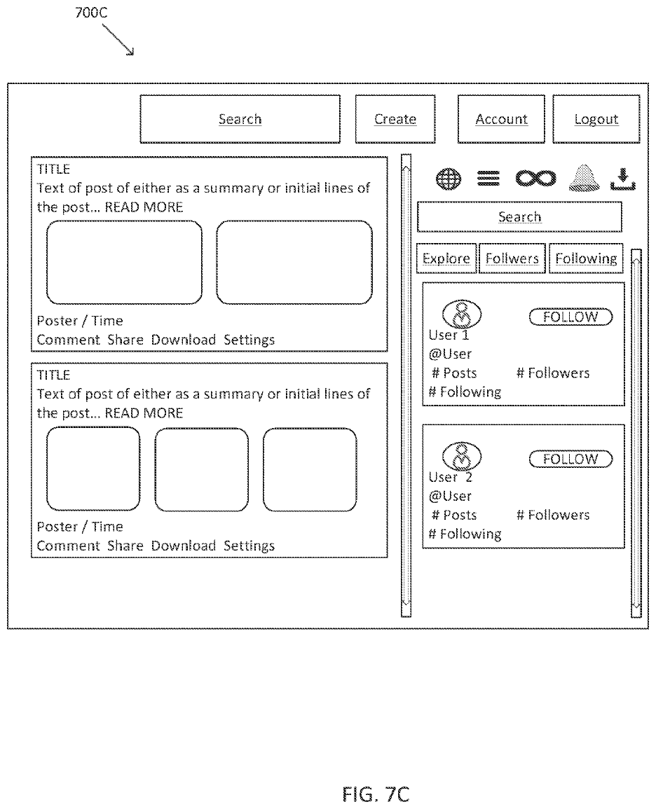

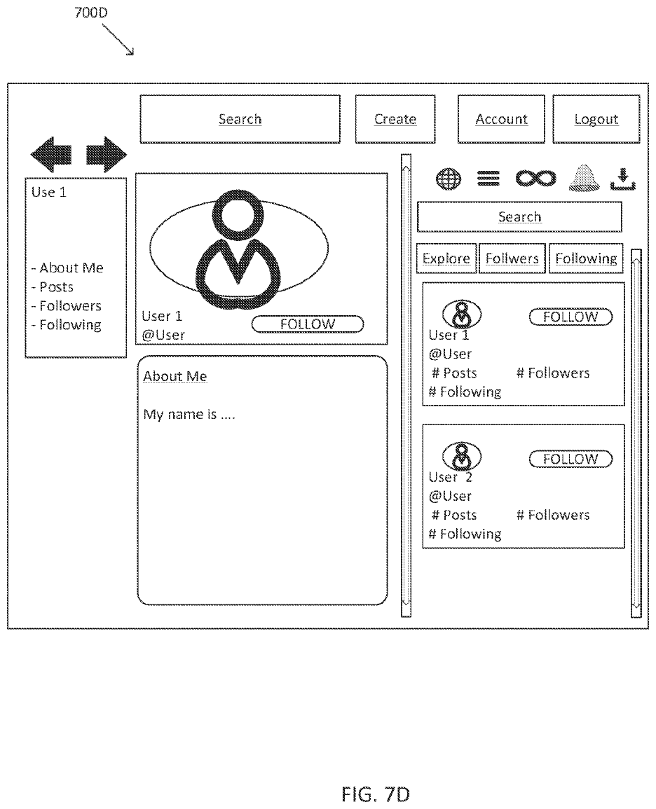

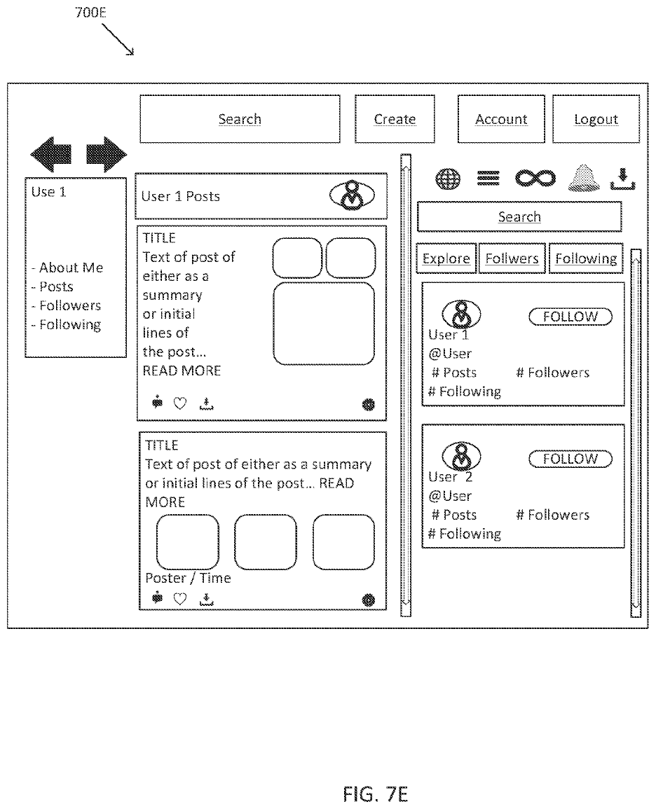

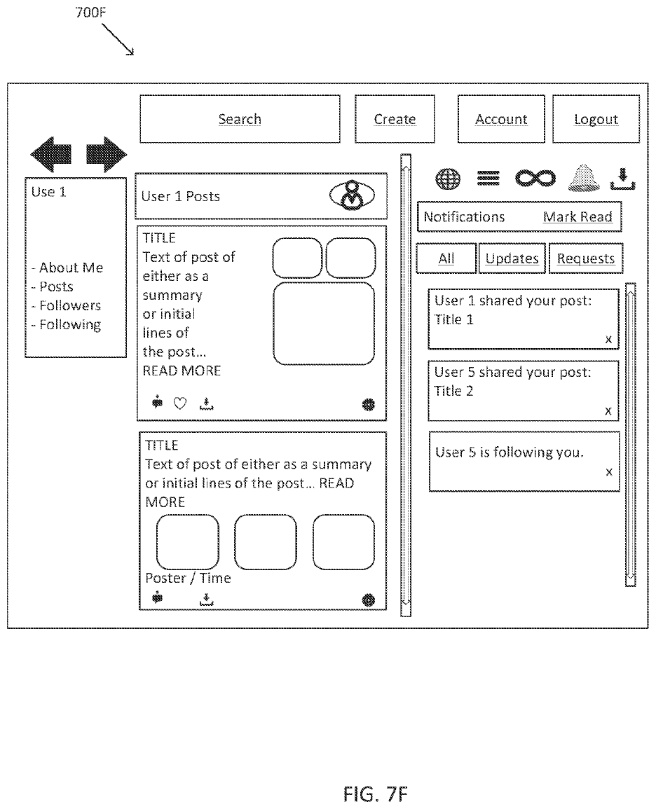

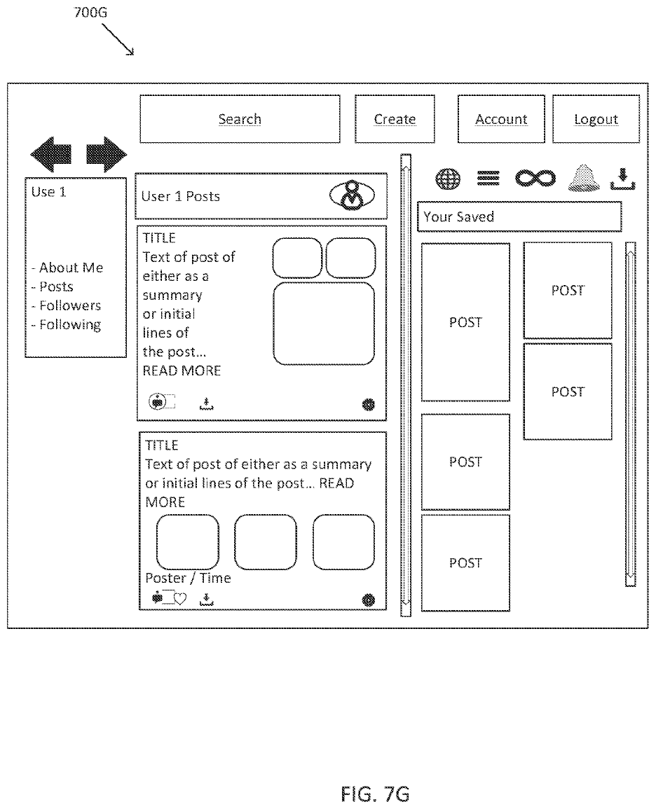

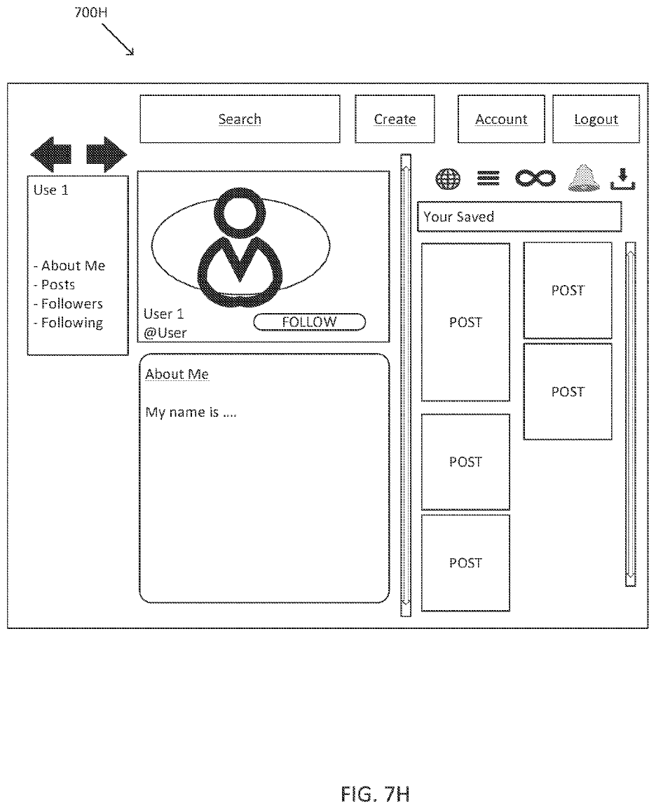

FIGS. 7A-7H illustrate exemplary user interfaces navigated by a user according to the method described herein. FIG. 7A illustrates an exemplary original display configuration 700A before a first user input. The original display includes a first content area defining user control options, a second content area displaying a first plurality of content related to content currently trending, and a third content area displaying a second plurality of content related to content being followed by the user. FIG. 7B illustrates an exemplary user display configuration 700B after a user input selecting a feeds criteria from the first content area. FIG. 7C illustrates an exemplary user display configuration 700C after a user input selection of connection criteria from the first content area. FIG. 7D illustrates an exemplary user display configuration 700D after a user input selection of an individual one of the plurality of content displayed in the second content. In this case, it is a selection of an individual connection from user display configuration of FIG. 7C. In this case, the third content area is updated with the content associated with the selection of the individual content of the second content area as the first and second content areas remain static. The third content area may include additional navigation controls, such as, for example, the connection information, the posts by the connection, the followers of the connection, and those other users following the connection. Selection of these navigation controls may further update the third content area, or the second content area. FIG. 7E illustrates an exemplary user display configuration 700E after a user input selection of the additional navigation controls within the third content area of FIG. 7D selecting the posts associated with a user. FIG. 7F illustrates an exemplary user display configuration 700F after a user input selecting a notifications criteria from the first content area. As illustrated, the second content area is updated with the selection, while the third content area remains static with the last selection from FIG. 7E. The second content area includes additional navigational controls associated with the selection content, including, for example, selections to display all notifications, new notifications, updates, or content requests (such as requests to follow). FIG. 7G illustrates an exemplary user display configuration 700G after a user input selecting a saved or downloaded content criteria from the first content area. As seen, the second content area is updated with the selection displaying a plurality of content corresponding to the contents saved by the user. FIG. 7H illustrates an exemplary user display configuration 700H after a user input selecting the navigate backwards within the third content area, thus navigating to a previous display of the third content area, while the second and first content areas remain static.

Exemplary embodiments provided herein may include permissions based system for receiving and display information to the system. Permissions based embodiments may include setting different permissions for a user or multiple users to send and receive information. For example, a user may indicate a category for other users, such as friends, family, co-workers, etc. When content is created, the user may indicate a group of users to share the content. Therefore, the user may identify a subgroup of users to provide content. When receiving the content, the user may fall within the permissions associated with the content before it is displayed to the user. Permissions may include whether the recipient of content is the user associated with the page to which the content will be posted. Permissions may include restrictions such as age or parental limitations based on a classification of the received content. Permissions may include any restriction put on the inputting or retrieving of information to or from the system.

As described herein, exemplary embodiments of the system permit a user to provide and receive content in new and efficient ways. Conventionally, social informational exchanges do not permit easy searching. For example, if a chat is occurring between users, a word search can be conducted for the exact words as it appears in the exchange. However, if an abbreviation, slang, alternative word or phrase, or misspelling occurs, then the exchange will not be captured or returned in any search result list. Also, straight word searches do not permit a user to receive information about a topic, category, or alternative grouping of information beyond the presence or absence of a specific word. In an exemplary embodiment, the system described herein may either manually, automatically, or a combination thereof associate content with tags and other attributes to improve searching, retrieval, and categorization of the information.

In an exemplary embodiment, when a user creates content, the system may provide a user with a template associated with the content type. The template associated with a content type may include different attributes, such as a topic, description, tags, key words, categories, title, other attribute or combinations thereof. The different attributes may be associated with the content and may be used to search, select, identify, categorize, or otherwise select or deselect content. For example, the categories, tags, or keywords may be used by the system to determine what content to display in one or more feeds of the user.

In an exemplary embodiment, when a user creates content, the system receives and analyzes the content, including any attributes associated with the user provided information. The system may use the received information to generate tag words to improve searching and retrieval of content. In an exemplary embodiment, the system may use a description of the content received by the user to create a set of keywords to identify and categorize the content. In an exemplary embodiment, the system may use a list of keywords provided by the user to generate a set of tags to identify the content. The generated keywords may include synonyms, spelling alternatives, related terms, or other association, and combinations thereof to identify the content. The keywords may be associated with the content and may be used to identify, retrieve, or otherwise manage the content.

In an exemplary embodiment, the associated attributes, whether manually entered or generated by the system, such as tags or keywords, may be used to retrieve content. In an exemplary embodiment, the retrieved content may be displayed after selecting or defining a feed according to embodiments described herein. A feed may be defined by one or more tags or keywords. The feed display may therefore provide a list, partial view of content, or full view of content having tags or keywords associated therewith related to tags or keywords provided by the user or defining the feed.

When conducting a search based on tags or keywords, the system may be configured to search for related tags or keywords that encompass the tag or keyword that may be related to the content. In an exemplary embodiment, a tag or keyword may be related hierarchically to higher level associations based on categories and descriptions. The system may therefore define a higher order relationship between one tag or keyword and another tag or keyword. For example, a piece of content may have a tag or keyword “kitty” associated with it. The system may be configured to relate the keyword “kitty” with other keywords hierarchically. Therefore, “kitty” would be associated on the same level as synonyms such as “kitten”, but would be associated on a different level (either higher or lower) as words that define or encompass “kitty” such as “pet”, “domestic animal”, etc. The hierarchical associations may be used to return relevant content that is defined by one keyword but fits within the group defined by a different keyword. Therefore, when a content is tagged with “kitty” and a user is searching for “pet”, the system can relate kitty as a valid result and within the category of pet, even if pet is not an actual tag or keyword associated with the content. The system may also be configured to attribute additional keywords to a content based on word associations. The system may therefore add the keyword pet directly to the content for present or future searching. The addition of the keyword may be at the time the content is created and saved to the system and/or at some time thereafter, such as when a search is conducted.

In an exemplary embodiment, the association between keywords may be dynamic and evolve over time. The system may therefore learn from the interactions of users with the system. For example, the system may permit the user to conduct a search. The system may record the actions of the user in response to the search results, such as identify which content the user spends time on and which content the user passes over. The system may rank additional keywords associated with these other content to increment or decrement a priority association between different keywords. For example, the user may have searched for kitty, and the system had an association for cat. However, as users interact with the system, users skip over content having the keyword cat and stop on content having the keyword kitten. The system may rank the association between keywords and weight them accordingly. In other words, the association to kitty would elevate kitten with a higher weight than the association to cat that would have a lower weight. The weights may be determined in how content is ordered, in determining which content is displayed, or in indicating a degree of fit to the original search parameter.

Illustrated herein are exemplary user interface according to embodiments described herein. In an exemplary embodiment, the user may change the user interface or layout. For example, the displayed information section may provide a first view in which information is displayed based on the content type in a predefined format and simply provided chronologically by upload or postdate. The user may be permitted to reconfigure the system and change the display. The user may be permitted to display a timeline of events. The user may be permitted to display a video or picture feed of content. The user may be permitted to change the priority of display from chronological to subject, author, specific keyword, filter criteria, or combinations thereof.

As illustrated herein, exemplary user interfaces may provide different sections or content areas for displaying different available actions of the user. For example, there are sections for creating content, filtering content, displaying content, summarizing content, etc. The system may be configured to receive inputs from a user to change the display attributes of one or more of these sections. For example, the user may identify the most likely types of content to be created for display in the create content section. The system may be configured to permit the user to change or position the different sections based on their preference. The system may provide different templates of display options for selection by the user. The system may permit the user to dynamically position sections of the user interface.

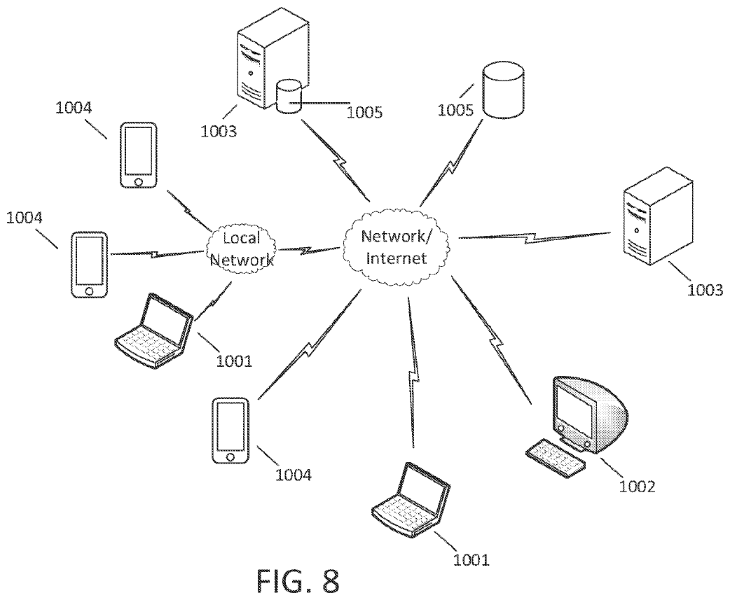

FIG. 8 illustrates exemplary embodiments of a social networking platform according to embodiments described herein that can include receiving and sending different content types to different users. Exemplary embodiments of the social networking platform described herein may include a computer, computers, electronic device, or electronic devices. As used herein, the term computer(s) and/or electronic device(s) are intended to be broadly interpreted to include a variety of systems and devices including personal computers 1002, laptop computers 1002, mainframe computers, servers 1003, set top boxes, digital versatile disc (DVD) players, mobile phone 1004, tablet, smart watch, smart displays, televisions, and the like. A computer can include, for example, processors, memory components for storing data (e.g., read only memory (ROM) and/or random access memory (RAM), other storage devices, various input/output communication devices and/or modules for network interface capabilities, etc. For example, the system may include a processing unit including a memory, a processor, an analog-to-digital converter (A/D), a plurality of software routines that may be stored as non-transitory, machine readable instruction on the memory and executed by the processor to perform the processes described herein. The processing unit may be based on a variety of commercially available platforms such as a personal computer, a workstation a laptop, a tablet, a mobile electronic device, or may be based on a custom platform that uses application-specific integrated circuits (ASICs) and other custom circuitry to carry out the processes described herein. Additionally, the processing unit may be coupled to one or more input/output (I/O) devices that enable a user to interface to the system. By way of example only, the processing unit may receive user inputs via a keyboard, touchscreen, mouse, scanner, button, or any other data input device and may provide graphical displays to the user via a display unit, which may be, for example, a conventional video monitor. The system may also include one or more large area networks, and/or local networks for communicating data from one or more different components of the system. The one or more electronic devices may therefore input a user interface for displaying information to a user and/or one or more input devices for receiving information from a user. The system may receive and/or display the information after communication to or from a remote server 1003 or database 1005.

Exemplary embodiments of the system described herein can be based in software and/or hardware. While some specific embodiments of the invention have been shown the invention is not to be limited to these embodiments. For example, most functions performed by electronic hardware components may be duplicated by software emulation. Thus, a software program written to accomplish those same functions may emulate the functionality of the hardware components in input-output circuitry. The invention is to be understood as not limited by the specific embodiments described herein, but only by scope of the appended claims.

Exemplary embodiments of the system integrate previously distinct experiences available on the internet. The integration of the different systems provides a unique environment for creating, sharing, and receiving content. The system provides improvements and previously unavailable functions that make the experience with the internet and sharing of content more efficient and convenient. Exemplary embodiments may be used to improve retrieval and searching of social exchanges. Exemplary embodiments may be used to improve sharing, searching, and retrieving relevant information from different exchanges such as chat, pages, social content, and more. Exemplary embodiments may be used for the display in different forms based on the preference of the user.

Although embodiments of this invention have been described with reference to the accompanying drawings, it is to be noted that various changes and modifications will become apparent to those skilled in the art. Such changes and modifications are to be understood as being included within the scope of embodiments of this invention as defined by the appended claims. Exemplary embodiments are provided herein as examples only. Embodiments include any combination of features described herein and one example is not limited to the features of that example, but each feature may be subdivided, combined, duplicated, deleted, or otherwise recombined together with any other feature associated with any embodiment described herein.

1. A method for receiving and displaying content to a user of an electronic device, comprising:
receiving a plurality of separate content from a plurality of users;
displaying a user interface to the user of the electronic device, wherein the user interface includes:
a first area for defining a predefined plurality of filters for filtering the plurality of separate content from the plurality of users;
a second area for displaying a second plurality of separate content from the plurality of users, where the second plurality is a subset of the plurality of separate content based on a user selection; and
a third area for displaying information to the user;
receiving an input from the user from a selection of the predefined plurality of filters;
displaying the second plurality of the plurality of separate content in a summary form in the second area.

2. The method of claim 1, wherein the third area for displaying information to the user includes a third plurality of separate content from the plurality of users, where the third plurality is a subset of the plurality of separate content, and the third plurality is displayed to the user in summary form such that each of the separate content is not displayed in full in the third area.

3. The method of claim 2, wherein the third plurality of separate content is defined by a predefined selection of criteria.

4. The method of claim 3, wherein the third plurality of separate content is defined by a user selection from more than one predefined selection of criteria.

5. The method of claim 2, further comprising receiving a second input from the user related to a selection of one of the second plurality of the plurality of separate content and displaying a full content associated with the selection of the one of the second plurality of the plurality of separate content.

6. The method of claim 5, wherein the full content is displayed within the second area, replacing the display of the second plurality of the plurality of separate content.

7. The method of claim 5, wherein the full content is displayed within the third area.

8. The method of claim 1, wherein the first area includes a first scroll feature for navigating the first area independent of the second area and third area, the second area includes a second scroll feature for navigating the second area independent of the first area and the third area, and the third area includes a third scroll feature for navigating the third area independent of the first area and the second area, and the method further comprises receiving an input from the user through the second scroll feature for scrolling the second plurality of the plurality of separate content such that portions of the second plurality of the plurality of separate content is shown to the user independent of a position of content displayed in the first area and the third area.

9. The method of claim 1, further comprising creating an instance of separate content by receiving a user creation input indicating a template for content creation.

10. The method of claim 9, further comprising receiving data from the user to fill the template including video, image, text, audio, and combinations thereof.

11. The method of claim 10, wherein the received data includes a video, and the method further comprises receiving a modification input from the user to modify the video.

12. The method of claim 11, wherein the modification input includes zooming and cropping an image of the video.

13. The method of claim 9, further comprising receiving one or more tags from the user to associate with the instant of separate content.

14. The method of claim 1, wherein each separate content of the plurality of separate content has associated therewith a tag, and the method further comprises receiving a search criteria from the user and running a search of the plurality of content based on the search criteria against the tags associated with each separate content to return a fourth plurality of separate content.

15. The method of claim 14, further comprising attaching additional tags to each separate content of the plurality of separate content.

16. The method of claim 15, wherein the additional tags are automatically generated by a system generating the user interface.
